(19) United States
(12) Patent Application Publication
(10) Pub. No.: US 2007/0097348 A1
(43) Pub. Date: May 3, 2007

(54) Distance and/or speed measuring device and accelerometer based relative position sensing

(76) Inventors: James Francis Kelly, Dunwoody, GA (US); Benjamin Joel Landry, Flowery Branch, GA (US)

Correspondence Address: James Kelly, 2827 Peterson Place, Norcross, GA, 30071, US

(21) Appl. No.: 11/265,487

(22) Filed: Nov. 3, 2005

(51) Int. Cl. G01C 3/08

(52) U.S. Cl. 356/4.01; 356/28

(57) ABSTRACT

A new technology combination that uses a distance or speed measuring device such as the proven time-of-flight based laser measuring devices with Magneto-Inductive (MI) bearing sensing and a Micro-Electro-Mechanical Systems (MEMS) Accelerometers to measure the relative position and relationship in space of objects individually or to other objects. This combination creates a range and orientation sensing system that does not require time consuming leveling before use.

### CROSS-REFERENCE TO RELATED APPLICATIONS

| | | | |
|---|---|---|---|
| 4344705 | Aug. 17, 1982 | Kompa, et al. | 356/5.08 |
| 4518256 | May 1985 | Schwartz | 356/28. |
| 5204731 | April 1993 | Tanaka et al. | |
| 5221956 | June 1993 | Patterson et al. | 356/28. |
| 5291262 | Mar. 1, 1994 | Dunne. | 356/5.06 |
| 5,508,588 | Apr. 9, 1996 | Diefes, et al. | 342/357.11 |
| 5523835 | June 1996 | Tanaka | 356/5. |
| 5552878 | September 1996 | Dillard | 356/5. |
| 5600436 | February 1997 | Gudat | 356/141. |
| 5612779 | March 1997 | Dunne | 356/5. |
| 5644386 | July 1997 | Jenkins et al. | 356/4. |
| 5,751,074 | May 12, 1998 | Prior, et al. | 307/118 |
| 5760748 | June 1998 | Beckingham | 356/4. |
| 5815251 | September 1998 | Ehbets et al. | 356/5. |
| 5859693 | January 1999 | Dunne et al. | 356/4. |
| 6590640 | Jul. 20, 2000 | Aiken, et al. | 356/3.01 |
| 6108071 | Aug. 22, 2000 | Landry, et al. | 365/5.05 |
| 6,621,460 | Sep. 16, 2003 | Challoner | 343/766 |

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF INVENTION

1. Field of the Invention

The invention relates to an apparatus and method for determining the relative position of an object. In particular, the invention relates to a device incorporating a rangefinder, accelerometer, compass and global positioning system receiver, wherein the device is capable of determining the location and/or speed of a target object.

2. Background of the Related Art

Use of a distance measuring device allows an operator to determine their relative position to a target object. When coupled with the distance to a second target object, the operator can determine the bearing (azimuth) and height (elevation), respectively between the operator's position and the position of the two target objects. There are many distance measuring devices which can increase the accuracy of this process. However, the mechanics related to this invention are similar to this description.

Laser rangefinders have been utilized for many applications in surveying and mapping. In surveying, a single surveyor, instead of two, can measure distance, bearing, and inclination with great accuracy, as illustrated in U.S. Pat. No. 5,291,262 to Dunne, the contents of which are hereby incorporated by reference. The mechanics of the laser rangefinder uses an infrared beam that hits a reflective target where the reflected beam is used to detect range and uses optical encoders and stepper motors to measure bearing and inclination to accuracies better than a fraction of an inch.

Laser rangefinders have also been incorporated in speed determination devices, such as the laser speed detectors used by law enforcement personnel. Examples of such devices are disclosed in U.S. Pat. No. 5,221,956 to Patterson et al. and U.S. Pat. No. 5,359,404 to Dunne, the contents of both of which are hereby incorporated by reference. In these devices, the rangefinder determines the distance to a target object at a plurality of different points in time. The determined distances and the elapsed times between measurements are then used to calculate the speed of the target.

In laser rangefinding and speed determination, typically, a short duration infrared laser light pulse is transmitted from the laser rangefinder to the target. The target reflects a portion of the laser pulse back to the laser rangefinder. The laser pulse transmitted from the rangefinder will diverge as it travels from the laser rangefinder to the target. After the laser pulse is reflected from the target, it will further diverge as it travels back toward the rangefinder. The power of the reflected laser pulse that is detected by the laser rangefinder is therefore a function of the effective solid angle subtended by the detecting portion of the laser rangefinder relative to the target, the divergence of the beam, the initial beam intensity and the reflectivity of the target.

Prior art laser rangefinders have utilized the functions of the Global Position System (GPS) to locate the exact position of measured objects. Typically, a separate GPS receiver is connected to a rangefinder via a data cable through a data input port. The rangefinder uses the location of the GPS receiver, and information derived from its own sensors, to determine the position of a measured object. Unfortunately, this arrangement requires the use of two separate devices, the rangefinder and a separate GPS receiver, which is cumbersome and impractical for some types of field work. An example of such devices are disclosed in U.S. Pat. No. 6,590,640 to Aiken, et al. and U.S. Pat. No. 5,506,588 to Diefes, et al.

Modern Theodolight and Laser Total Station uses infrared beam that hits a reflection device and bounces back to detect range and uses optical encoders and stepper motors to measure bearing and inclination to accuracies better than a fraction of an inch. To be this accurate requires, among other things, that the Theodolight or total station be meticulously leveled. As not all relative position and mapping work requires fraction of inch accuracy, time-of-flight based laser distance measuring equipment was integrated with low resolution angle encoders and fluid tilt sensor to create fraction of a foot accurate systems. The accuracy of fluid tilt sensors vary with temperature and the accuracy decays with time, especially when the fluid sensor is stored in unusual attitudes for extended periods.

Another prior art method of determining azimuth and elevation is to utilize gravitational forces on liquids to measure the movement of the liquid relative to the body which contains the liquid. An example of such a device is disclosed in U.S. Pat. No. 5,751,074 to Prior, et al. In this context, the application of determining relative positioning is not feasible without the use of a distance measuring device. Another method of measuring the gravitational force to measure three dimensional relative orientation is through the use of an accelerometer which acts similar to that previously described here. The details of the accelerometer are disclosed in U.S. Pat. No. 6,621,460 to Challoner.

The above references are incorporated by reference herein where appropriate for appropriate teachings of additional or alternative details, features and/or technical background.

This patent discloses a new technology combination that uses a distance measuring device along with a three dimensional relative orientation gravitational device to determine relative positioning including but not limited to the use of flight based laser distance and speed measuring devices with Magneto-Inductive (MI) bearing sensing and Micro-Electro-Mechanical Systems (MEMS) Accelerometers to measure inclination.

### BRIEF SUMMARY OF THE INVENTION

This invention allows a user to gather relative positional information and create 6 inch or better accurate maps more reliable and in less time then classical survey methods. Using a distance measuring device including to but not limited to a laser distance sensor such as a Laser Atlanta Advantage™, a Laser Atlanta SpeedLaser® in conjunction with a bearing sensing such as a Magneto-Inductive (MI) sensor, optical encoder or stepper motor, integrated internally or externally with a MEMS Accelerometer the relative position of other objects and hence the creation directly or indirectly of various types of site map can be expedited.

### Brief Description of the Several Views of the Drawing

Not Applicable

### DETAILED DESCRIPTION OF THE INVENTION

This patent discloses a new technology combination that uses a distance measuring device such as the proven time-of-flight based laser distance and/or speed measuring devices with Magneto-Inductive (MI) bearing sensing and a Micro-Electro-Mechanical Systems (MEMS) Accelerometers to measure the relative position and relationship in space of objects individually or to other objects. This combination creates a range and orientation sensing system that does not require time consuming leveling before use.

With the results of the distance measuring device and the accelerometer in conjunction with the MEMS, the relative position of the target with respect to the originating position can be determined. The process of determining the relative position does not include a calibration step for orientation of the measuring device with respect to the accelerometer because of the inherent nature of the accelerometer and the physical mechanics of the accelerometer.

This invention allows a user to gather relative positional information and create 6 inch or better accurate maps more reliable and in less time then classical survey methods using a laser distance sensor such as a Laser Atlanta Advantage, a Laser Atlanta Speed Laser or any other distance measuring sensor in conjunction with a bearing sensing such as a Magneto-Inductive (MI) sensor, optical encoder or stepper motor, integrated internally or externally with a MEMS Accelerometer.

The invention may be embodied in an inexpensive, lightweight, compact and rugged casing. The device may include a viewfinder having a target sight and a head-up display which allows a user to observe both a target object and information regarding the target object simultaneously through the viewfinder. The device does not require a folded telephoto lens, or a compound lens system to project an image of target information on the head-up display. In addition, elements for creating an image of target information and a reticule for aiming the device at a target object are incorporated into a single light emitting display. The optical elements used in the head-up display are optimized for transmissivity and reflectivity such that the viewfinder of the head-up display accurately portrays both a target image and an image of the target information. Further, the target information and reticule image is projected onto the viewfinder such that they appear to be a great distance away from the operator, which allows the operator to focus his eyes at infinity and easily simultaneously see both the target object and the target information.

The device may also transfer information to a remote device using communication methods including but not limited to analog and digital information transfer methods. This information may also be printed on a display screen or on a printing device to a tangible medium.

The device may also incorporate a power supply, in the form of rechargeable batteries, which is integrally mounted in a detachable handle of the unit. This eliminates the need for an exterior power supply or an exterior battery pack, and serves to balance the device so that it is easier to control.

A device embodying the invention may also be pre-programmed to carry out certain forms of asset surveying. For instance, the device may be pre-programmed to accomplish horizontal/vertical profiling, to determine the volume of three dimensional objects, or to determine the area of two dimensional plots.

What is claimed is:

1. A method of determining a distance to a target object and relative positioning to that target comprising a distance measuring device and an accelerometer.

2. Apparatus of claim 1 for determining relative positioning comprising of:
a. a MEMS Accelerometer for measuring orientation in combination with any distance measuring sensor for range
b. either a Magneto-Inductive (MI) sensor, optical encoder or stepper motor for bearing.

3. The apparatus of claim 2 may comprise a laser distance sensor such as a Laser Atlanta Advantage, a Laser Atlanta SpeedLaser or any other distance measuring sensor in conjunction with a bearing sensing such as a Magneto-Inductive (MI) sensor, optical encoder or stepper motor, integrated internally or externally with a MEMS Accelerometer.
a. Using this combination of technology, the relative position of other objects and hence the creation directly or indirectly of various types of site map can be expedited.
b. Using this combination of technology, the relative position of other objects and hence the creation directly or indirectly of various types of contour plotting can be expedited.
c. Using this combination of technology, the relative position of other objects and hence the creation directly or indirectly of various types of height measurements can be created and expedited.
d. Using this combination of technology, the relative position of other objects and hence the creation directly or indirectly of various types of length measurements can be created and expedited.
e. Using this combination of technology, the relative position of other objects and hence the creation directly or indirectly of various types of distance and distance traveled measurements can be created and expedited.
f. Using this combination of technology, the relative position of other objects and hence the creation directly or indirectly of various types of speed and acceleration measurements can be created and expedited.
